(19) United States
(12) Patent Application Publication
(10) Pub. No.: US 2026/0254856 A1
(43) Pub. Date: Aug. 27, 2026

(54) INSTALLING SELECTED SOURCE ROLE-FOCUSED POLICIES

(71) Applicant: HEWLETT PACKARD ENTERPRISE DEVELOPMENT LP, Spring, TX (US)

(72) Inventors: Rajib Majila, Bangalore (IN); Ram Lakhan Patel, Bangalore (IN)

(21) Appl. No.: 19/192,117

(22) Filed: Apr. 28, 2025

(30) Foreign Application Priority Data
Feb. 26, 2025 (IN) 202541017155

(51) Int. Cl. H04L 9/40

(52) U.S. Cl. CPC H04L 63/20; H04L 63/104

(57) ABSTRACT

In some examples, a processing resource converts destination role-focused policies to a plurality of source role-focused policies, and selects a collection of source role-focused policies from among the plurality of source role-focused policies based on a source network address and a destination network address in a first data packet. The processing resource installs the selected collection of source role-focused policies in a policy enforcement hardware controller in an ingress network device for a source compute entity, the policy enforcement hardware controller to enforce a source role-focused policy of the selected collection of source role-focused policies at the ingress network device in response to a second data packet received from the source compute entity.

### BACKGROUND

Compute entities are able to communicate with one another or access resources in a network environment. The compute entities can be divided into multiple groups according to roles of the compute entities. Group-based policies can be applied at enforcement points in the network environment.

### BRIEF DESCRIPTION OF THE DRAWINGS

Some implementations of the present disclosure are described with respect to the following figures.

FIG. 1 is a block diagram of an arrangement including network switches according to some examples.

FIG. 2 is a flow diagram of a process of a control plane for a switch, according to some examples.

FIG. 3 is a block diagram of a storage medium storing machine-readable instructions according to some examples.

FIG. 4 is a block diagram of a network device according to some examples.

FIG. 5 is a flow diagram of a process according to some examples.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Group-based policies that are applied with respect to respective groups of compute entities can control the way the compute entities are able to communicate in a network environment, what resources are accessible by the compute entities, actions that may be taken by the compute entities, or other aspects of the compute entities. A compute entity can include an electronic device or a virtual compute entity such as a virtual machine (VM) or a container. To determine which group a particular compute entity is to be assigned, a role of the particular compute entity is determined. A “role” of a compute entity can refer to a property (or properties) of the compute entity, and/or of a user of the compute entity. For example, a role of the compute entity can include any or some combination of the following: a guest role (indicating that the compute entity is associated with a user that is visiting the network environment), an employee role (indicating that the compute entity is associated with a user that is an employee of an organization), a role of a specific department within an organization (indicating that the compute entity is associated with a user that works in the specific department), a responsibility or assigned function of the compute entity, a capability of the compute entity, or any other characteristic of the compute entity.

A network includes network devices (e.g., switches) through which data packets are transferred. A source compute entity that transmits a data packet may be connected to an ingress network device, while a destination compute entity to which the data packet is targeted may be connected to an egress network device. The ingress network device is the network device at which a data packet transmitted by the source compute entity is received to forward over the network, and the egress network device is the network device at which the data packet transmitted over the network is received for forwarding to the destination compute entity. In some examples, role-to-role policy enforcement can be applied at the egress network device, in which the group-based policy to apply is determined based on a source role of the source compute entity and a destination role of the destination compute entity. Performing policy enforcement at the egress network device can be inefficient, since the data packet has to traverse across the network to the egress network device to determine what group-based policy is applied. If the applied group-based policy indicates that the data packet is to be dropped, then the transmission of the data packet across the network has consumed network resources unnecessarily. A large quantity of data packets (from many compute entities) that are ultimately dropped due to policy enforcements at egress network devices can use up a significant portion of the network bandwidth, which can result in reduced network bandwidth availability or reduced data rates for data communications across the network.

In accordance with some implementations of the present disclosure, group-based policies can be enforced at ingress network devices rather than egress network devices based on use of group-based polices that are source role-focused instead of destination role-focused, and based on selective installation of source role-focused group-based polices in policy enforcement hardware controllers of the ingress network devices for more efficient utilization of the policy enforcement hardware controllers.

Group-based policy enforcement is based on both the source role of a source compute entity and the destination role of a destination compute entity. As a result, to be able to enforce a group-based policy at an ingress network device, the ingress network device would have to be aware of both the source role of a source compute entity connected to the ingress network device, as well as the destination role of a destination compute entity that may be connected to a different network device. For group-based policy enforcement at an egress network device, the source role of the source compute entity can be included in a role tag that is added to a header (e.g., a virtual tunnel header) of a data packet sent from the ingress network device to the egress network device. However, using a role tag to indicate the destination role of the destination compute entity is not possible for group-based policy enforcement at the ingress network device. Distributing role information of roles of all compute entities to many network devices of a computing environment can result in wasteful consumption of network and processing resources, especially if the computing environment has a large quantity of compute entities. Additionally, the mapping of roles to compute entities (or more specifically, the mapping of roles to network addresses of compute entities) can present a scaling issue if mapping information used to perform the mapping grows large and overwhelms the resources of network devices.

Further, installing a large quantity of group-based policies in a policy enforcement hardware controller of an ingress network device may not be feasible or efficient. In some examples, the policy enforcement hardware controller includes a Ternary Content-addressable Memory (TCAM), which is relatively small and thus may not have the capacity to store a large quantity of group-based policies. Since destination roles of potential destination compute entities to which source compute entities may send data packets may not be predictable ahead of time, a possible example technique may install group-based policies for all destination compute entities in the policy enforcement hardware controller of the ingress network device. This can overwhelm the capacity of the policy enforcement hardware controller.

In some examples of the present disclosure, the selection of source role-focused group-based polices (or more simply, “source role-focused policies”) to install at a policy enforcement hardware controller of an ingress network device can be based on data packets actually transmitted by a source compute entity. Each data packet contains a source network address identifying the source compute entity, and a destination network address identifying a destination compute entity. A control plane associated with the ingress network device can determine the source role corresponding to the source network address, and the destination role corresponding to the destination network address. The control plane selects a collection of source role-focused policies for this source role-destination role pair.

As used here, a “collection” of items can refer to a single item or multiple items. Thus, a collection of source role-focused policies can include a single source role-focused policy or multiple source role-focused policies.

A source role-focused policy includes an entry containing a source role mapped to one or more destination roles. The entry of the source role-focused policy indicates whether a data packet from a source compute entity having the source role targeted to a destination compute entity having any of the one or more destination roles is permitted. The source role-focused policy is different from a destination role-focused policy, which has an entry containing a destination role mapped to one or more source roles.

A destination role-focused policy is a group-based policy that indicates whether a class of data traffic is permitted from a collection of source roles to a destination role. A source role-focused policy is a group-based policy that indicates whether a collection of destination roles are permitted to receive a class of data traffic from a source role.

Techniques or mechanisms according to some examples of the present disclosure improve computer functionality or the technology of network communications by allowing enforcement of group-based policies for compute entities at ingress network devices so that network bandwidth is not wasted in communicating data packets to egress network devices for policy enforcement. The ability to enforce group-based policies closer to sources of data packets allows for more efficient usage of network resources. For example, if a group-based policy specifies that a particular data packet from a source compute entity to a destination compute entity is to be dropped, then enforcing this group-based policy at the ingress network device (which is closer to the source of the data packet) means that the data packet can be dropped at the ingress network device before the data packet is transmitted further across a network. Reducing the amount of data traffic transferred across a network can also reduce the costs associated with data communications and reduce the resource usage of network devices.

Enforcement of source role-focused policies according to some examples of the present disclosure is applied with respect to unicast data packets. A unicast data packet is sent from a source CE to a single destination network address identifying a destination CE.

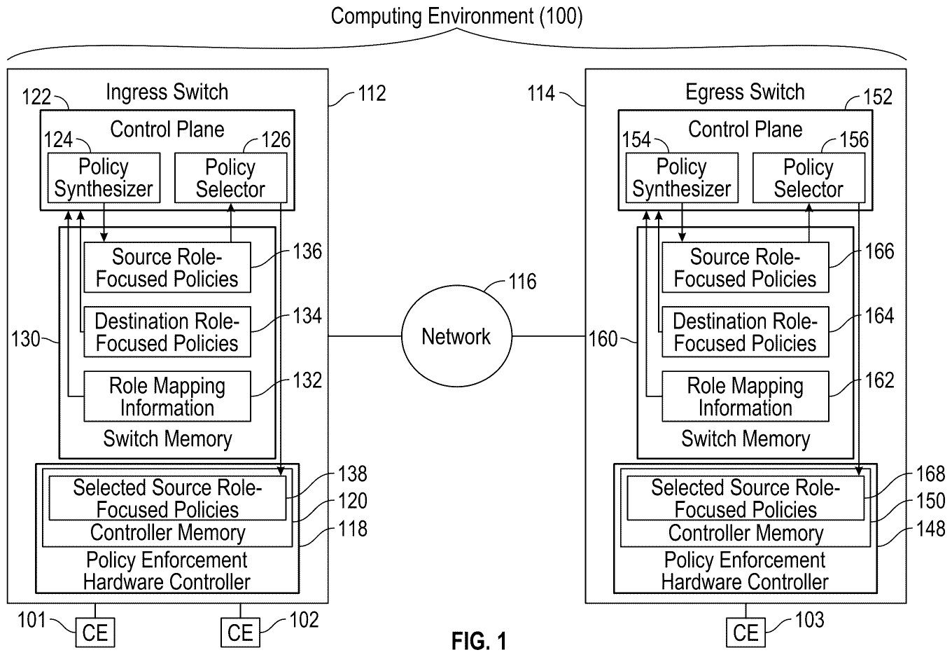

FIG. 1 is a block diagram of an example arrangement that includes switches 112 and 114, which can be part of a computing environment 100. The switches 112 and 114 are connected over a network 116. Although just two switches are shown in FIG. 1, the computing environment 100 may include more switches in other examples.

Each switch is connected to a number of compute entities (CEs). For example, the switch 112 is connected to CEs 101 and 102, and the switch 114 is connected to a CE 103. In other examples, each switch can be connected to a different quantity of CEs.

The switches 112 and 114 are access switches that connect to CEs. The network 116 can include additional switches, such as aggregation switches and/or core switches. The additional switches can receive data packets of source CEs from ingress switches for forwarding to egress switches, which in turn forward the data packets to destination CEs.

A “switch” can refer to either a layer 2 switch or a layer 3 router that forwards data packets based on network addresses in the data packets. The switches 112 and 114 are examples of network devices.

A “network device” can refer to any electronic device that forwards data along network paths of a network. The switch can be a layer 2 switch that forwards a data packet based on a destination Media Access Control (MAC) address in the data packet. Alternatively, the switch can be a layer 3 router that forwards a data packet based on a source Internet Protocol (IP) address and a destination IP address in the data packet. A network device may also include a gateway or any other device for forwarding data.

The switches 112 and 114 may be part of the same domain or may be part of different domains. Examples of domains include any of the following: data centers, campuses, geographic sites, communication fabrics, or other types of domains. If the switches 112 and 114 are part of different domains (e.g., different campuses), then the network 116 can include a wide area network (WAN) for interconnecting the different domains.

In the example of FIG. 1, the switch 112 is referred to as an ingress switch and the switch 114 is referred to as an egress switch. The ingress switch 112 is the switch connected to a source CE (e.g., 101 or 102) that transmits data to a destination CE (e.g., 103). In a different example, the switch 114 is an ingress switch for a source CE (e.g., 103) that sends data to a destination CE (e.g., 101 or 102), and the switch 112 is an egress switch connected to the destination CE.

In accordance with some examples of the present disclosure, enforcement of group-based policies can be performed at an ingress switch, such as the ingress switch 112. The ingress switch 112 includes a policy enforcement hardware controller 118 that is used to enforce group-based policies. The policy enforcement hardware controller 118 includes a hardware processing resource that can perform policy enforcement operations. In some examples, the policy enforcement hardware controller 118 may execute machine-readable instructions (e.g., firmware or software) to perform the policy enforcement operations.

The policy enforcement hardware controller 118 includes a controller memory 120. In an example, the controller memory 120 is part of a Ternary Content-Addressable Memory (TCAM) in the policy enforcement hardware controller 118. A TCAM is a special type of high-speed memory that can search its entire content within a single clock cycle of a clock signal according to which the policy enforcement hardware controller 118 operates.

The ingress switch 112 also includes a control plane 122. The control plane 122 includes a policy synthesizer 124 and a policy selector 126. A “control plane” of a switch includes components that perform control tasks of the switch, where the control tasks are distinguished from data packet handling tasks of a “data plane” of the switch. Data packet handling can include forwarding data packets and/or manipulating data packets, including encapsulating data packets, modifying fields of data packets, and so forth. The policy enforcement hardware controller 118 is part of the data plane of the ingress switch 112.

The ingress switch 112 further includes a switch memory 130 that stores role mapping information 132, destination role-focused policies 134, and source role-focused policies 136. The role mapping information 132 correlates roles to network addresses, such as IP addresses. For a given network address (e.g., a given IP address), a lookup of the role mapping information 132 produces a corresponding role for the given network address.

The policy synthesizer 124 received as input the destination role-focused policies 134, and produces as output the source role-focused policies 136. A discussion of how the policy synthesis performed by the policy synthesizer 124 is provided further below.

The policy selector 126 selects, from among the source role-focused policies 136, selected source role-focused policies 138 that are installed to the controller memory 120, such as a TCAM, of the policy enforcement hardware controller 118. Installing the selected source role-focused policies 138 in the controller memory 120 includes writing the selected source role-focused policies 138 to the controller memory 120.

The policy enforcement hardware controller 118 can apply policy enforcement with respect to a data packet from a source CE (e.g. 101 or 102) connected to the ingress switch 112 that is targeted to a destination CE (e.g., 103) connected to the egress switch 114.

The egress switch 114 includes a similar arrangement of components as the ingress switch 112. The egress switch 114 includes a policy enforcement hardware controller 148, a control plane 152 that includes a policy synthesizer 154 and a policy selector 156, and a switch memory 160 that stores role mapping information 162, destination role-focused policies 164, and source role-focused policies 166. The policy synthesizer 154 produces the source role-focused policies 166 based on the destination role-focused policies 164. The policy selector 156 selects, from among the source role-focused policies 166, selected source role-focused policies 168 that are installed to a controller memory 150 of the policy enforcement hardware controller 148.

In some examples, the network 116 is a Layer 3 underlay network, such as an IP underlay network. A Layer 2 overlay network, e.g., an Ethernet network, can be provided over the Layer 3 underlay network. A protocol that supports communications through a Layer 2 overlay network provided over a Layer 3 underlay network is the Virtual Extensible Local Area Network (VXLAN) protocol. According to the VXLAN protocol, virtual tunnels referred to as VXLAN tunnels can be established between virtual tunnel endpoints (VTEPs) to communicate data. In the example of FIG. 1, the VTEPs can be included in the ingress and egress switches 112 and 114. A VXLAN tunnel encapsulates Layer 2 frames of the Layer 2 overlay network as payloads in Layer 3 packets. The Layer 3 packets are communicated through the Layer 3 underlay network. A network in which frames of a Layer 2 overlay network are carried in a Layer 3 underlay network is referred to as an “underlay and overlay network.” A network device, such as a network switch or another type of network device that forwards data, can include a VTEP, which is a data plane entity that performs VXLAN encapsulation and decapsulation.

Although reference is made to VXLAN in some examples, it is noted that in other examples, VXLAN is not employed. In such other examples, the network 116 can include any other type of network, including a local area network (LAN), a wide area network (WAN), the Internet, or any other type of network.

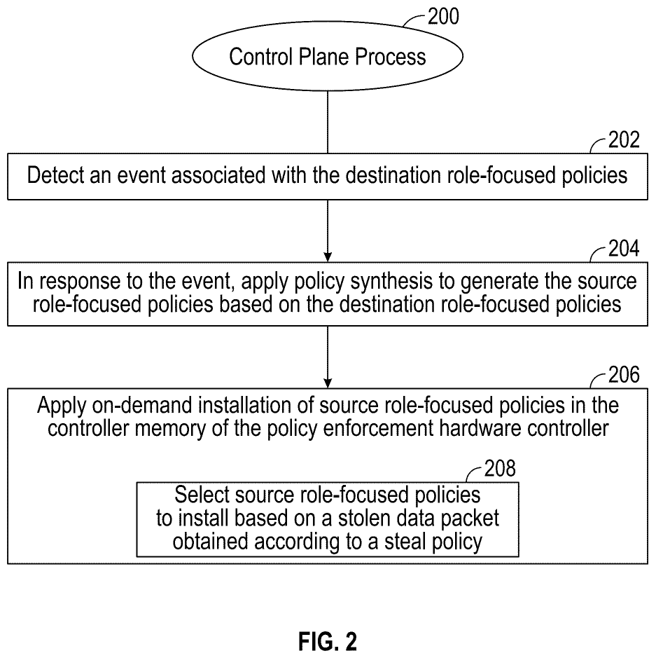

FIG. 2 is a flow diagram of a process 200 of a control plane, such as the control plane 122 or 152, in an ingress switch (e.g., 112 or 114). In the discussion of FIG. 2, it is assumed that the control plane 122 of the switch 112 performs the tasks of FIG. 2. In other examples, the control plane of the switch 114 can perform similar tasks.

The control plane 122 detects (at 202) an event associated with the destination role-focused policies 134. The event can include adding, modifying, or removing any of the destination role-focused policies 134 in the switch memory 130.

In response to the event, the policy synthesizer 124 applies policy synthesis (at 204) to generate the source role-focused policies 136 based on the destination role-focused policies 134. The policy synthesis is discussed further below.

The policy selector 126 applies (at 206) on-demand installation of source role-focused policies (including the selected source role-focused policies 138) in the controller memory 120 of the policy enforcement hardware controller 118. The on-demand installation of source role-focused policies in the controller memory 120 reduces how many source role-focused policies are added to the controller memory 120, which reduces resource consumption of the controller memory 120. In this way, storage entries of the controller memory 120 can be preserved for source role-focused policies that actually will be used (as opposed to source role-focused policies that may not be used).

In some examples, as part of the on-demand installation, the policy selector 126 selects (at 208) source role-focused policies to install based on a stolen data packet obtained according to a steal policy. When a traffic flow (including a data packet) is generated from a newly connected source CE, the policy enforcement hardware controller 118 in the ingress switch 112 determines whether any source role-focused policy is installed in the controller memory 120 for the source role of the newly connected source CE. The “newly connected” source CE is a CE that previously did not have a connection to the ingress switch 112, or a CE that had terminated its connection with the ingress switch 112.

If the policy enforcement hardware controller 118 determines that no source role-focused policy is installed in the controller memory 120 for the source role of the newly connected source CE, the steal policy is invoked at the ingress switch 112, where the steal policy causes the policy enforcement hardware controller 118 to (1) “steal” the data packet by copying the stolen data packet to a central processing unit (CPU) that executes the control plane 122 the ingress switch 112, and (2) drop the stolen data packet. Dropping the stolen data packet ensures that the data packet will not be forwarded by the ingress switch 112 when no source role-focused policy exists yet for the source role of the newly connected source CE. Note that the on-demand installation of source role-focused policies in policy enforcement hardware controllers means that there is some likelihood that a source role-focused policy will not yet be installed when source CEs newly connect to ingress switches.

Copying the stolen data packet to the CPU of the ingress switch 112 refers to writing the stolen data packet to a memory accessible to the CPU. This memory may be the switch memory 130, for example. The stolen data packet when written to the CPU-accessible memory triggers the installation of one or more source role-focused policies for a source-destination role combination. The source-destination role combination includes a source role corresponding to the source network address (that identifies the source compute entity) in the stolen data packet, and a destination role corresponding to the destination network address (that identifies the destination compute entity) in the stolen data packet.

The policy selector 126 identifies which of the source role-focused policies 136 stored in the switch memory 130 contains the source role and the destination role associated with the stolen data packet. The identified source role-focused policy is selected by the policy selector 126 for installation in the controller memory 120 as one of the selected source role-focused policies 138. For a given source-destination role combination, all source role-focused policies that are relevant for the given source-destination role combination are installed. A particular source role-focused policy is relevant for the given source-destination role combination if the source role-focused policy contains the source role and the destination role of the given source role-focused policy-note that the particular source role-focused policy may possibly contain one or more other destination roles not in the given source-destination role combination.

The policy selector 126 does not install other source role-focused policies for source-destination role combinations not observed in data packets received from source CEs at the ingress switch 112.

In the above examples, the policy selector 126 determines the source role corresponding to the source network address in the stolen data packet, and the destination role corresponding to the destination network address in the stolen data packet. Although roles of locally attached CEs may be known to the ingress switch 112, it is noted that the ingress switch 112 may not be aware of roles of CEs connected to remote switches, such as the egress switch 114. To determine the destination role of a CE connected to a remote switch, the policy selector 126 in the ingress switch 112 can access the role mapping information 132. The policy selector 126 can use the destination network address in the stolen data packet to perform a lookup of the role mapping information 132 to determine the destination role corresponding to the destination network address of the stolen data packet.

In some examples, the lookup of the role mapping information 132 can use a longest prefix match of the destination network address in the stolen data packet to network addresses (e.g., IP addresses) in entries of the role mapping information 132. In examples where the role mapping information 132 is a role trie, the lookup starts at the root of the role trie and proceeds through intermediate nodes of the role trie until a match to an entry of a leaf node of the role trie is detected. The role trie can include a Patricia trie (also referred to as a radix tree). A trie is a tree-based data structure used for locating specific keys. In a role trie, the keys include IP addresses of CEs. The role trie includes a root node, intermediate nodes connected to the root node, and leaf nodes connected to the intermediate nodes. Each leaf node maps an IP address of a CE to a corresponding role.

In other examples, the role mapping information 132 is in a different form, such as a simple list of entries mapping IP addresses to roles, a sorted list (e.g., sorted based on the length of a prefix of an IP address) of entries mapping IP addresses to roles, a binary search tree, or any other type of data structure.

The following describes some examples of how source role-focused policies can be synthesized from destination role-focused policies by a policy synthesizer (e.g., 124 or 154 in FIG. 1). Table 1 below shows three example destination role-focused policies DP1, DP2, and DP3. The destination role-focused policies of Table 1 may be applied by egress switches to data packets to segment traffic based on roles.

TABLE 1

| | Associated | |
|---|---|---|
| Policy | Destination Role | Policy Entries |
| DP1 | Finance | 10 Source Role Admin, Destination Role Finance, IP Protocol TCP, L4 |
| | | Port 10-100 is Allowed |
| | | 20 Source Role Any, Destination Role Finance, IP Protocol TCP |
| | | Traffic, L4 Port 80 is Allowed |
| DP2 | Admin | 10 Source Role Finance, Destination Role Admin, IP Protocol TCP, L4 |
| | | Port 80 is Denied |
| | | 20 Source Role Any, Destination Role Admin, IP Protocol TCP, L4 |
| | | Port 10-1000 is Allowed |
| DP3 | Security | 10 Source Role Admin, Destination Role Security, IP Protocol UDP, |
| | | L4 Port any is Denied |
| | | 20 Source Role Security, Destination Role Security, IP Protocol TCP, |
| | | L4 Port 90 is Denied |
| | | 30 Source Role Any, Destination Role Security, IP Protocol any, L4 |
| | | Port any is Allowed |

The destination role-focused policy DP1 indicates permissions for a destination role “Finance” (e.g., a destination CE has the Finance role), the destination role-focused policy DP2 indicates permissions for a destination role “Admin,” and the destination role-focused policy DP3 indicates permissions for a destination role “Security.” In the example of Table 1, the destination role-focused policy DP1 has policy entries 10 and 20 (which are sequence numbers), the destination role-focused policy DP2 has policy entries 10 and 20, and the destination role-focused policy DP3 has policy entries 10, 20, and 30. More generally, a destination role-focused policy includes one or more policy entries.

The policy entry 10 of DP1 can indicate: a sequence number of “10”; a source role of “Admin”; a destination role of “Finance”; traffic attributes of “IP Protocol (Transmission Control Protocol) TCP” and “L4 Port 10-100”; and an action of “Allowed.” The policy entry 10 of DP1 can indicate: a sequence number of “20”; a source role of “Any”; a destination role of “Finance”; traffic attributes of “IP Protocol TCP Traffic” and “L4 Port 80”; and an action of “Allowed.” The policy entry 10 of DP3 can indicate: a sequence number of “10”; a source role of “Admin”; a destination role of “Security”; traffic attributes of “IP Protocol UDP” and “L4 Port any”; and an action of “Denied.”

In the example of Table 1, the policy entry 10 of DP1 indicates that TCP traffic on any of ports 10-100 is permitted from the source role “Admin” to the destination role “Finance.” The policy entry 20 of DP1 indicates that TCP traffic on port 80 is permitted from any source role to the destination role “Finance.” The policy entries of the destination role-focused policies DP2 and DP3 indicate other permitted traffic to respective destination roles. For example, the policy entry 10 of DP3 indicates that TCP traffic on any User Datagram Protocol (UDP) port from the source role “Admin” to the destination role “Security” is denied.

The policy synthesizer applies a policy synthesis algorithm that generates source role-focused polices from destination role-focused policies (e.g., the policies of Table 1). The policy synthesis algorithm implodes the ranges (e.g., “L4 Port 10-100” in policy entry 10 of DP1) and wild cards (e.g., “L4 Port any” in policy entry 10 of DP3) in the destination role-focused policies. The policy synthesis algorithm transposes the policies to orient against the source roles and maps the policies to a set of destination roles. The policy synthesis algorithm also removes any overlap by creating multiple policies out of overlapping ones, and eliminates the generated policies that would not satisfy any of the originally configured policies. The policy synthesis algorithm applies further optimization by combining policies wherever possible, and then re-sequences the policies to ensure more specific entries get a higher priority compared to the policies that have properties set to wildcards or ranges. Further details regarding the policy synthesis algorithm are provided in U.S. Patent Publication No. 2023/0113466, which is hereby incorporated by reference.

Table 2 below is an example of source role-focused policies generated from Table 1 by applying the policy synthesis algorithm.

TABLE 2

| | | | Allowed Destination |
|---|---|---|---|
| Policy | Source Role | Match Element | Role Set |
| SP1 | Admin | 10 IP Protocol TCP, L4 Port 0-9 | {Security, Admin} |
| | | 20 IP Protocol TCP Traffic, L4 Port 10- | {Finance, Admin, Security} |
| | | 100 | {Admin, Security} |
| | | 30 IP Protocol TCP, L4 Port 101-65535 | {Admin} |
| | | 40 IP Protocol UDP, L4 Port any | {Security, Admin} |
| | | 50 IP Protocol any, L4 Port any | |
| SP2 | Security | 10 IP Protocol TCP Traffic, L4 Port 0-9 | {Security} |
| | | 20 IP Protocol TCP, L4 Port 10-79 | {Admin, Security} |
| | | 30 IP Protocol any, L4 Port 80-80 | {Security, Finance, Admin} |
| | | 40 IP Protocol TCP, L4 Port 81-89 | {Admin, Security} |
| | | 50 IP Protocol TCP, L4 Port 90-90 | {Admin} |
| | | 60 IP Protocol TCP, L4 Port 91-1000 | {Admin, Security} |
| | | 70 IP Protocol TCP, L4 Port 1001- | {Security} |
| | | 65535 | {Security} |
| | | 80 IP Protocol any, L4 Port any | |
| SP3 | Finance | 10 IP Protocol TCP Traffic, L4 Port 0-9 | {Finance, Security} |
| | | 20 IP Protocol TCP, L4 Port 10-79 | {Finance, Admin, Security} |
| | | 30 IP Protocol TCP, L4 Port 80-80 | {Security, Finance} |
| | | 40 IP Protocol TCP, L4 Port 81-1000 | {Finance, Admin, Security} |
| | | 50 IP Protocol TCP, L4 Port 1001-65535 | {Security, Finance} |
| | | 60 IP Protocol any, L4 Port any | {Security, Finance} |

Table 2 shows three source role-focused policies SP1, SP2, and SP3. In the example of Table 2, each source role-focused policy has multiple policy entries. For example, the source role-focused policy SP1 has policy entries 10, 20, 30, 40, and 50 (which are sequence numbers); the source role-focused policy SP2 has policy entries 10, 20, 30, 40, 50, 60, 70, and 80; and the source role-focused policy SP1 has policy entries 10, 20, 30, 40, 50, and 60. More generally, a source role-focused policy has one or more policy entries.

Each policy entry can contain source role s, a match element (in the “Match Element” column of Table 2), and an action element (in the “Allowed Destination Role Set” column of Table 2. The match element can contain a collection of match elements to match traffic attribute(s) m; of an incoming data packet. In Table 2, policy entry 10 of the source role-focused policy SP1 has a source role “Admin”; a match element with the following traffic attributes: “IP Protocol, TCP, L4 Port 0-9”; and an allowed destination role set including {Security, Admin}. Thus, according to policy entry 10 of the source role-focused policy SP1, a policy enforcement hardware controller in an ingress switch will permit forwarding of a data packet with traffic attributes “IP Protocol, TCP, L4 Port 0-9” from source role “Admin” to either destination role “Security” or “Admin.” The sequence numbers in each source role-focused policy indicate relative priorities of the policy entries, with a lower sequence number indicating a higher priority. If a data packet matches multiple policy entries of a source role-focused policy, the policy entry to be applied by the policy enforcement hardware controller is the policy entry with a higher priority (lower sequence number).

Although Table 2 includes an “Allowed Destination Role Set” that identifies destination roles that are allowed, a different example can include a “Denied Destination Role Set” that identifies destination roles that are denied.

In some examples, the source role-focused policies of Table 2 can be converted to source role-focused policies for respective source-destination role combinations, such as according to Table 3 below.

TABLE 3

| | Source | Destina- | |
|---|---|---|---|
| Policy | Role | tion Role | Match Element |
| SPA | Admin | Admin | 10 IP Protocol TCP, L4 Port 0-9 |
| | | | 20 IP Protocol TCP Traffic, L4 Port |
| | | | 10-100 |
| | | | 30 IP Protocol TCP, L4 Port 101-65535 |
| | | | 40 IP Protocol UDP, L4 Port any |
| | | | 50 IP Protocol any, L4 Port any |
| SPB | | Finance | 10 IP Protocol TCP Traffic, L4 Port |
| | | | 10-100 |
| SPC | | Security | 10 IP Protocol TCP, L4 Port 0-9 |
| | | | 20 IP Protocol TCP Traffic, L4 Port |
| | | | 10-100 |
| | | | 30 IP Protocol TCP, L4 Port 101-65535 |
| | | | 40 IP Protocol any, L4 Port any |
| SPD | Finance | Admin | 10 IP Protocol TCP, L4 Port 10-79 |
| SPE | | Finance | 10 IP Protocol TCP Traffic, L4 Port 0-9 |
| | | | 20 IP Protocol TCP, L4 Port 10-79 |
| | | | 30 IP Protocol TCP, L4 Port 80-80 |
| SPF | | Security | 10 IP Protocol TCP Traffic, L4 Port 0-9 |
| | | | 20 IP Protocol TCP, L4 Port 10-79 |
| | | | 30 IP Protocol TCP, L4 Port 80-80 |
| SPG | Security | Admin | 10 IP Protocol TCP, L4 Port 10-79 |
| | | | 20 IP Protocol any, L4 Port 80-80 |
| | | | 30 IP Protocol TCP, L4 Port 81-89 |
| | | | 40 IP Protocol TCP, L4 Port 90-90 |
| | | | 50 IP Protocol TCP, L4 Port 91-1000 |
| SPH | | Finance | 10 IP Protocol any, L4 Port 80-80 |
| SPI | | Security | 10 IP Protocol TCP Traffic, L4 Port 0-9 |
| | | | 20 IP Protocol TCP, L4 Port 10-79 |
| | | | 30 IP Protocol any, L4 Port 80-80 |
| | | | 40 IP Protocol TCP, L4 Port 81-89 |
| | | | 50 IP Protocol TCP, L4 Port 91-1000 |
| | | | 60 IP Protocol TCP, L4 Port 1001-65535 |
| | | | 70 IP Protocol any, L4 Port any |

In Table 3, a source role-focused policy is specified for each source-destination role combination. For example, a source role-focused policy SPA specified for the combination of the source role “Admin” and the destination role “Admin” has policy entries 10, 20, 30, 40, and 50. The “Match Element” column can contain a collection of match elements to match traffic attribute(s) mi of an incoming data packet. A source role-focused policy SPB specified for the combination of the source role “Admin” and the destination role “Finance” has policy entry 10; a source role-focused policy SPC specified for the combination of the source role “Admin” and the destination role “Security” has policy entries 10, 20, 30, and 40; a source role-focused policy SPD specified for the combination of the source role “Finance” and the destination role “Admin” has policy entry 10; a source role-focused policy SPE specified for the combination of the source role “Finance” and the destination role “Finance” has policy entries 10, 20, and 30; a source role-focused policy SPF specified for the combination of the source role “Finance” and the destination role “Security” has policy entries 10, 20, and 30; a source role-focused policy SPG specified for the combination of the source role “Security” and the destination role “Admin” has policy entries 10, 20, 30, 40, and 50; a source role-focused policy SPH specified for the combination of the source role “Security” and the destination role “Finance” has policy entry 10; and a source role-focused policy SPH specified for the combination of the source role “Security” and the destination role “Security” has policy entries 10, 20, 30, 40, 50, 60, and 70.

Thus, according to policy entry 10 of the source role-focused policy SPA, a policy enforcement hardware controller in an ingress switch will permit forwarding of a data packet with traffic attributes “IP Protocol, TCP, L4 Port 0-9” from source role “Admin” to destination role “Admin.” According to policy entry 20 of the source role-focused policy SPC, the policy enforcement hardware controller in the ingress switch will permit forwarding of a data packet with traffic attributes “IP Protocol, TCP, L4 Port 0-9” from source role “Admin” to destination role “Security.” If a data packet matches multiple policy entries of a source role-focused policy, the policy entry to be applied by the policy enforcement hardware controller is the policy entry with a higher priority (lower sequence number).

As noted further above, the switches 112 and 114 may be part of the same domain or may be part of different domains. If the switches 112 and 114 are part of the same domain, then the role mapping information (e.g., 132 or 162) stored in each switch includes roles mapped to destination IP addresses of all CEs in the domain. As a result, an ingress switch can readily determination a destination role for a destination IP address by looking up the role mapping information.

However, if the switches 112 and 114 are part of different domains, then the role mapping information (e.g., 132 or 162) stored in a switch of a first domain may not include roles mapped to destination IP addresses of CEs in a second domain different from the first domain. In such latter examples, out-of-band signaling can be performed between the different domains to provide roles and corresponding IP addresses of CEs in the second domain to switches in the first domain (and vice versa). For example, a switch in the second domain when authenticating a CE in the second domain can send the role and IP address of the CE to switches in the first domain.

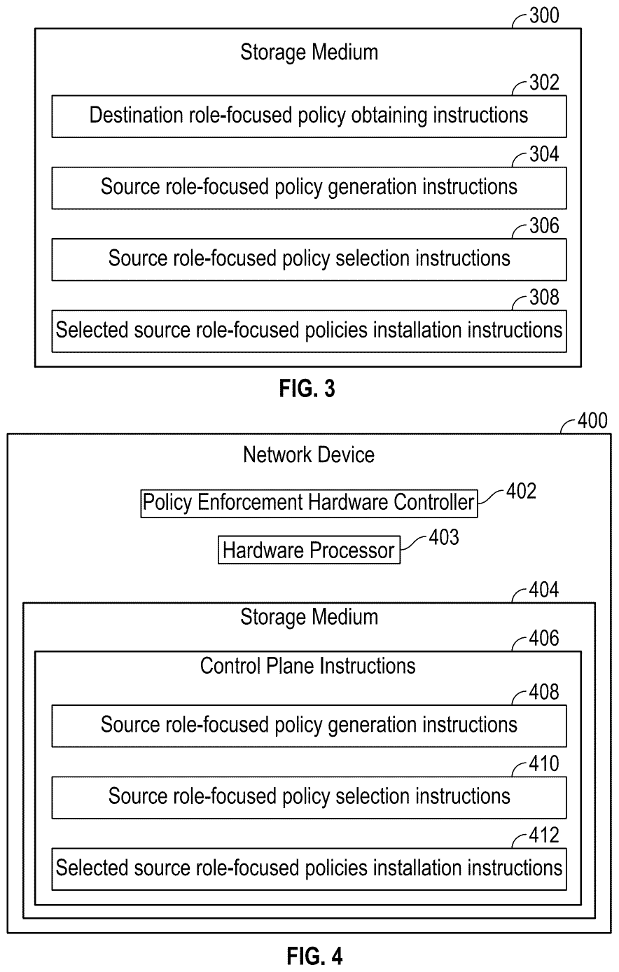

FIG. 3 is a block diagram of a non-transitory machine-readable or computer-readable storage medium 300 storing machine-readable instructions that upon execution cause a processing resource to perform various tasks. In some examples, the processing resource is part of an ingress network device (e.g., the ingress switch 112 of FIG. 1). In other examples, the processing resource is part of a control system separate from switches. In such other examples, a policy synthesizer and a policy selector may be run in the control system to install selected source role-focused policies in respective ingress network devices.

The machine-readable instructions include destination role-focused policy obtaining instructions 302 to obtain destination role-focused policies. For example, the destination role-focused policies can be retrieved from a memory.

The machine-readable instructions include source role-focused policy generation instructions 304 to convert the destination role-focused policies to a plurality of source role-focused policies. For example, the destination role-focused policies of Table 1 may be converted to the source role-focused policies of Table 2 or 3.

The machine-readable instructions include source role-focused policy selection instructions 306 to select a collection of source role-focused policies from among the plurality of source role-focused policies based on a source network address and a destination network address in a first data packet. The first data packet may be part of a new traffic flow of a CE newly connected to the ingress network device.

The machine-readable instructions include selected source role-focused policies installation instructions 308 to install the selected collection of source role-focused policies in a policy enforcement hardware controller in the ingress network device for a source CE. The policy enforcement hardware controller enforces a source role-focused policy of the selected collection of source role-focused policies at the ingress network device in response to a second data packet received from the source CE.

In some examples, the selecting and the installing are triggered responsive to a connection of the source CE to the ingress network device and receipt of the first data packet.

In some examples, the selecting and the installing are triggered according to a steal policy specifying that a data packet from any source CE newly connected to the ingress network device is to be dropped and used to select source role-focused policies for installation.

In some examples, the first data packet is from the source CE, and the source network address identifies the source CE.

In some examples, a source role-focused policy is defined for a source role corresponding to the source network address, and a first destination role corresponding to the destination network address.

In some examples, the first destination role corresponding to the destination network address is associated with a destination CE that is part of the same domain as the source compute entity.

In some examples, the first destination role corresponding to the destination network address is associated with a destination CE that is part of a second domain different from a first domain that the source CE is part of.

In some examples, the machine-readable instructions can determine that a third data packet received at the ingress network device contains a destination network address corresponding to a second destination role different from the first destination role. The machine-readable instructions can determine whether the second destination role matches any destination role of source role-focused policies installed in the policy enforcement hardware controller. Based on determining that the second destination role does not match any destination role of source role-focused policies installed in the policy enforcement hardware controller, the machine-readable instructions can trigger an installation of a further source role-focused policy for the second destination role.

In some examples, the machine-readable instructions can access role mapping information that correlates roles to network addresses, and determine, based on the role mapping information, the source role corresponding to the source network address, and the first destination role corresponding to the destination network address.

In some examples, the role mapping information includes a tree structure having nodes each including a mapping of a network address to a role.

In some examples, a destination role-focused policy of the destination role-focused policies includes an entry containing a destination role mapped to a plurality of source roles, and a source role-focused policy of the source role-focused policies includes an entry containing a source role mapped to a plurality of destination roles.

FIG. 4 is a block diagram of a network device 400, such as the ingress switch 112 of FIG. 1. The network device 400 includes a policy enforcement hardware controller 402, which can be similar to the policy enforcement hardware controller 118 or 148 of FIG. 1.

The network device 400 includes a hardware processor 403 (or multiple hardware processors). A hardware processor can include a microprocessor, a core of a multi-core microprocessor, a microcontroller, a programmable integrated circuit, a programmable gate array, or another hardware processing circuit.

The network device 400 further includes a storage medium 404 storing control plane instructions 406 executable on the hardware processor 403 to perform various tasks. Machine-readable instructions executable on a hardware processor can refer to the instructions executable on a single hardware processor or the instructions executable on multiple hardware processors.

The control plane instructions 406 can be part of the control plane 122 or 152 of FIG. 1, for example. The control plane instructions 406 include source role-focused policy generation instructions 408 to generate a plurality of source role-focused policies based on destination role-focused policies. The generation of the plurality of source role-focused policies based on the destination role-focused policies is according to a policy synthesis algorithm.

The control plane instructions 406 include source role-focused policy selection instructions 410 to select a collection of source role-focused policies from among the plurality of source role-focused policies based on a source network address and a destination network address in a first data packet. The selection can be based on a stolen data packet obtained according to a steal policy, for example.

The control plane instructions 406 include selected source role-focused policies installation instructions 412 to install the selected collection of source role-focused policies in a controller memory of the policy enforcement hardware controller 402. The policy enforcement hardware controller 402 enforces a source role-focused policy of the selected collection of source role-focused policies at the network device in response to a second data packet received from a source CE.

In some examples, network device 400 is an ingress network device for the source CE.

In some examples, the policy enforcement hardware controller 402 determines, in response to the first data packet, whether a respective source role-focused policy for a source role corresponding to the source network address and a destination role corresponding to the destination network address is not present in the controller memory. Based on determining that the respective source role-focused policy is not present in the controller memory, the policy enforcement hardware controller 402 triggers an installation of the respective source role-focused policy by the control plane instructions 406 in the controller memory of the policy enforcement hardware controller 402. The respective source role-focused policy is part of the selected collection of source role-focused policies.

In some examples, the control plane instructions 406 can select the collection of source role-focused policies based on determining which of the plurality of source role-focused policies is relevant to a source role corresponding to the source network address and a destination role corresponding to the destination network address in the first data packet.

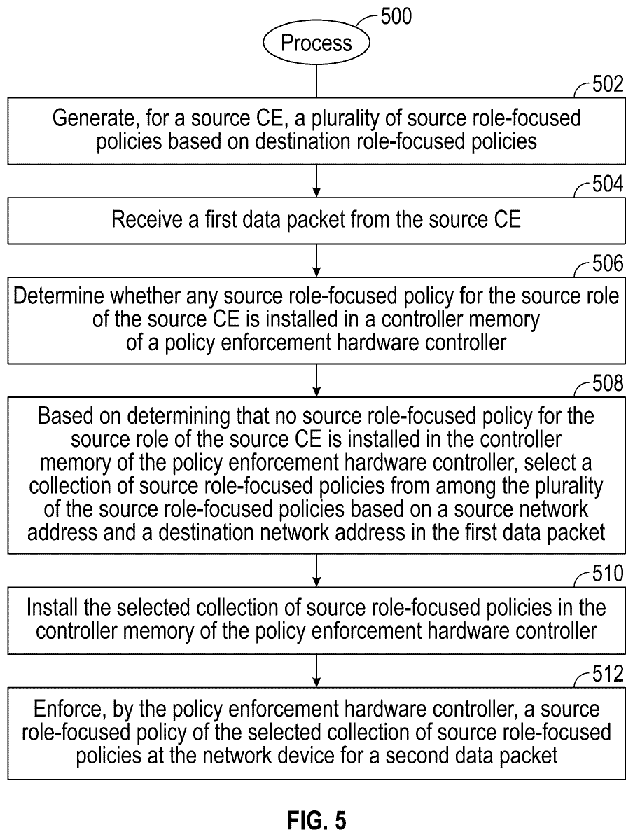

FIG. 5 is a flow diagram of a process 500 according to some examples.

The process 500 may be performed by an ingress network device (e.g., the ingress switch 112 in FIG. 1).

The process 500 includes generating (at 502), for a source CE, a plurality of source role-focused policies based on destination role-focused policies. The generation uses a policy synthesis algorithm.

The process 500 includes receiving (at 504) a first data packet from the source CE. The source CE may be newly connected to the ingress network device, and the first data packet may be part of a new traffic flow from the source CE.

The process 500 includes determining (at 506) whether any source role-focused policy for the source role of the source compute entity is installed in a controller memory of a policy enforcement hardware controller. The controller memory may be a TCAM, for example.

Based on determining that no source role-focused policy for the source role of the source compute entity is installed in the controller memory of the policy enforcement hardware controller, the process 500 includes selecting (at 508) a collection of source role-focused policies from among the plurality of source role-focused policies based on a source network address and a destination network address in the first data packet.

The process 500 includes installing (at 510) the selected collection of source role-focused policies in the controller memory of the policy enforcement hardware controller.

The process 500 includes enforcing (at 512), by the policy enforcement hardware controller in the ingress network device, a source role-focused policy of the selected collection of source role-focused policies at the network device for a second data packet received from the source compute entity.

As used here, a “processing resource” can include one or more hardware processors. The policy synthesizers and the policy selectors of FIG. 1 can be implemented with machine-readable instructions.

A “memory” is implemented with one or more memory devices. A memory device can include any or some combination of the following: a dynamic or static random access memory (a DRAM or SRAM) device, an erasable and programmable read-only memory (EPROM) device, an electrically erasable and programmable read-only memory (EEPROM) device, or a flash memory device.

FIG. 2 and FIG. 5 show specific orders of tasks. In other examples, the tasks may be performed in a different order, some tasks may be omitted, and other tasks may be added.

A storage medium (e.g., 300 in FIG. 3 or 404 in FIG. 4) can include any or some combination of the following: a semiconductor memory device such as a DRAM or SRAM, an EPROM, an EEPROM, or a flash memory; a magnetic disk such as a fixed, floppy and removable disk; another magnetic medium including tape; an optical medium such as a compact disk (CD) or a digital video disk (DVD); or another type of storage device. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the present disclosure, use of the term “a,” “an,” or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A non-transitory machine-readable storage medium comprising instructions that upon execution cause a processing resource to:
obtain destination role-focused policies;
convert the destination role-focused policies to a plurality of source role-focused policies;
select a collection of source role-focused policies from among the plurality of source role-focused policies based on a source network address and a destination network address in a first data packet; and
install the selected collection of source role-focused policies in a policy enforcement hardware controller in an ingress network device for a source compute entity, the policy enforcement hardware controller to enforce a source role-focused policy of the selected collection of source role-focused policies at the ingress network device in response to a second data packet received from the source compute entity.

2. The non-transitory machine-readable storage medium of claim 1, wherein the selecting and the installing are triggered responsive to a connection of the source compute entity to the ingress network device and receipt of the first data packet.

3. The non-transitory machine-readable storage medium of claim 2, wherein the selecting and the installing are triggered according to a steal policy specifying that a data packet from any source compute entity newly connected to the ingress network device is to be dropped and used to select source role-focused policies for installation.

4. The non-transitory machine-readable storage medium of claim 2, wherein the first data packet is from the source compute entity, and the source network address identifies the source compute entity.

5. The non-transitory machine-readable storage medium of claim 1, wherein the source role-focused policy of the selected collection of source role-focused policies is defined for a source role corresponding to the source network address, and a first destination role corresponding to the destination network address.

6. The non-transitory machine-readable storage medium of claim 5, wherein the first destination role corresponding to the destination network address is associated with a destination compute entity that is part of a same domain as the source compute entity.

7. The non-transitory machine-readable storage medium of claim 5, wherein the first destination role corresponding to the destination network address is associated with a destination compute entity that is part of a second domain different from a first domain that the source compute entity is part of.

8. The non-transitory machine-readable storage medium of claim 5, wherein the instructions upon execution cause the processing resource to:
determine that a third data packet received at the ingress network device contains a destination network address corresponding to a second destination role different from the first destination role;
determine whether the second destination role matches any destination role of source role-focused policies installed in the policy enforcement hardware controller; and
based on determining that the second destination role does not match any destination role of source role-focused policies installed in the policy enforcement hardware controller, trigger an installation of a further source role-focused policy for the second destination role.

9. The non-transitory machine-readable storage medium of claim 5, wherein the instructions upon execution cause the processing resource to:
access role mapping information that correlates roles to network addresses; and
determine, based on the role mapping information, the source role corresponding to the source network address, and the first destination role corresponding to the destination network address.

10. The non-transitory machine-readable storage medium of claim 9, wherein the role mapping information comprises a tree structure comprising nodes each including a mapping of a network address to a role.

11. The non-transitory machine-readable storage medium of claim 9, wherein the role mapping information correlates the roles to Internet Protocol (IP) addresses.

12. The non-transitory machine-readable storage medium of claim 1, wherein a destination role-focused policy of the destination role-focused policies comprises an entry containing a destination role mapped to a plurality of source roles, and
wherein a source role-focused policy of the source role-focused policies comprises an entry containing a source role mapped to a plurality of destination roles.

13. The non-transitory machine-readable storage medium of claim 1, wherein the processing resource is part of the ingress network device.

14. The non-transitory machine-readable storage medium of claim 1, wherein the selected collection of source role-focused policies is installed in a Ternary Content-addressable Memory (TCAM) of the policy enforcement hardware controller.

15. A network device comprising:
a policy enforcement hardware controller;
a hardware processor;
a non-transitory storage medium storing control plane instructions executable on the hardware processor to:
generate a plurality of source role-focused policies based on destination role-focused policies,
select a collection of source role-focused policies from among the plurality of source role-focused policies based on a source network address and a destination network address in a first data packet, and
install the selected collection of source role-focused policies in a controller memory of the policy enforcement hardware controller,
wherein the policy enforcement hardware controller to enforce a source role-focused policy of the selected collection of source role-focused policies at the network device in response to a second data packet received from a source compute entity.

16. The network device of claim 15, wherein the network device is an ingress network device for the source compute entity.

17. The network device of claim 15, wherein the policy enforcement hardware controller is to:
determine, in response to the first data packet, whether a respective source role-focused policy for a source role corresponding to the source network address and a destination role corresponding to the destination network address is not present in the controller memory,
based on determining that the respective source role-focused policy is not present in the controller memory, trigger an installation of the respective source role-focused policy by the control plane instructions in the controller memory of the policy enforcement hardware controller, the respective source role-focused policy being part of the selected collection of source role-focused policies.

18. The network device of claim 15, wherein the control plane instructions executable on the hardware processor to:
select the collection of source role-focused policies based on determining which of the plurality of source role-focused policies is relevant to a source role corresponding to the source network address and a destination role corresponding to the destination network address in the first data packet.

19. A method comprising:
generating, by an ingress network device for a source compute entity, a plurality of source role-focused policies based on destination role-focused policies;
receiving, by the ingress network device, a first data packet from the source compute entity;
determining, by the ingress network device, whether any source role-focused policy for a source role of the source compute entity is installed in a controller memory of a policy enforcement hardware controller;
based on determining that no source role-focused policy for the source role of the source compute entity is installed in the controller memory of the policy enforcement hardware controller, selecting, by the ingress network device, a collection of source role-focused policies from among the plurality of source role-focused policies based on a source network address and a destination network address in the first data packet; and
installing, by the ingress network device, the selected collection of source role-focused policies in the controller memory of the policy enforcement hardware controller; and
enforcing, by the policy enforcement hardware controller in the ingress network device, a source role-focused policy of the selected collection of source role-focused policies at the ingress network device for a second data packet received from the source compute entity.

20. The method of claim 19, wherein the selecting and the installing are performed according to a steal policy in which the first data packet is copied to a central processing unit (CPU) executing control plane instructions and the first data packet is dropped, wherein the control plane instructions perform the selecting and the installing.
